(19) United States
(12) Patent Application Publication
(10) Pub. No.: US 2012/0254800 A1
(43) Pub. Date: Oct. 4, 2012

(54) INDEPENDENT ATTRIBUTE FILTERING

(75) Inventors: Paul Richard Kristoff, Apex, NC (US); Harold Lee, Holly Springs, NC (US); Jason Stone, Holly Springs, NC (US); Henry Fu, Chapel Hill, NC (US); Marcus Philip Tidwell, North Royalton, OH (US)

(73) Assignee: Teradata US, Inc., Dayton, OH (US)

(21) Appl. No.: 13/075,906

(22) Filed: Mar. 30, 2011

(51) Int. Cl. G06F 3/048

(52) U.S. Cl. 715/825

(57) ABSTRACT

A graphical user interface (GUI) tool is presented to a user for interacting with an underlying database. The GUI tool includes a field selection and attribute selections for the field. The user selects a field and an attribute for that field and is presented with a first list of values retrieved from the database for the selected attribute. Next, the user selects a filter for the attribute within the GUI tool and a second reduced list of values is presented to the user within the GUI tool representing the filtered first list of values acquired by applying the filter.

### BACKGROUND

Increasingly enterprises are relying on information collected from customers and suppliers to run their organizations more efficiently. More and more types of information from a variety of sources are being collected and housed in enterprise data warehouses. The information is then mined from a variety of automated and manual sources for purposes of running the organization more efficiently and creating improved relationships with the customers of the enterprise.

A typical data warehouse, even for small enterprises, can be voluminous. For example, there may be thousands if not hundreds of thousands of customers for a single enterprise. Many marketing campaigns initiated by an enterprise entail using graphical user interfaces (GUIs) to run queries or reports against a data warehouse. These GUI interfaces often have pull down menus or fields that an analyst uses to construct a report or a query by selecting specific fields and values of a particular database table that are of interest.

The problem with these interfaces is that in many cases, the number of values for a given field can be quite large such that it becomes quite time consuming for an analyst to make the proper selections. For example, a sales associate field can have thousands of sales associate identifiers, each identifier identifying a particular sales associate. In such a situation, if an analyst wants to retrieve only particular sales associates, then the analyst is forced to do a lot more manual digging outside the GUI tool to add search criteria that will proper select just those sales associates of interest to the analyst because thousands of associate identifiers are of little use to the analyst in selecting the proper associates and even if they were of use the analyst would have to manually traverse a huge list to select the proper associates.

Therefore, existing database interfaces become more and more problematic from a usability standpoint as the volume of data, data fields, and data values increase for an underlying database.

### SUMMARY

In various embodiments, techniques for independent attribute filtering are presented. According to an embodiment, a method for independent attribute filtering within a database interface is provided.

More particularly, a graphical user interface (GUI) tool is presented to a user, the GUI tool acting as an interface for the user to access a database. Next, a field selection is received from the user for a field of the database within the GUI tool and an attribute selection is obtained from the user for an attribute assigned to the field within the GUI tool. Then, a first list of attribute values is retrieved from the database and assigned to the attribute for the field; the first list is displayed to the user within the GUI tool and an attribute filter is acquired from the user. Finally, the first list is filtered to present a reduced second list of attribute values within the GUI tool by applying the filter against the first list.

### BRIEF DESCRIPTION OF THE DRAWINGS

FIG. 1 is a method for independent attribute filtering within a database interface.

FIG. 2 is a diagram of another method for independent attribute filtering within a database interface, according to an example embodiment.

FIG. 3 is a diagram of an independent attribute filtering database interface system, according to an example embodiment.

### DETAILED DESCRIPTION

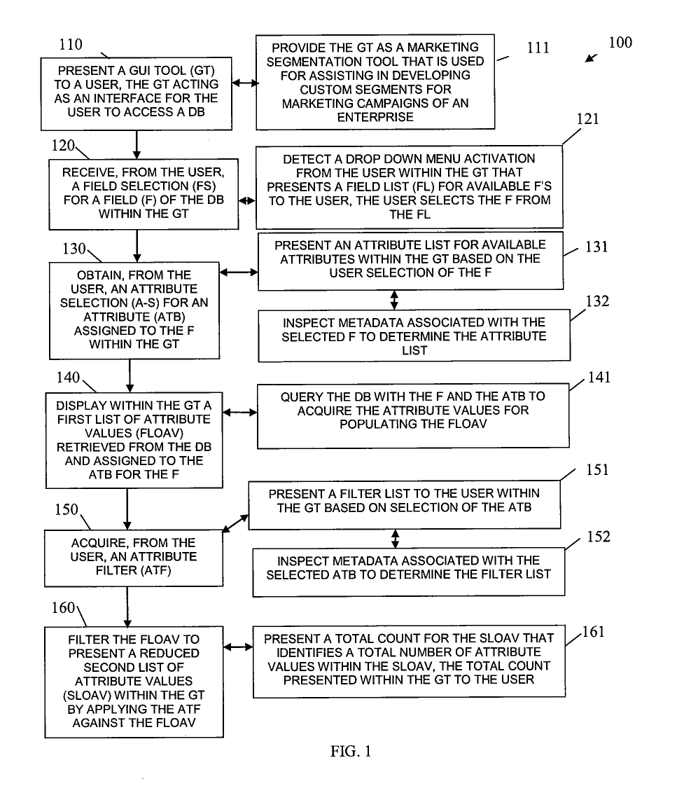

FIG. 1 is a method 100 for independent attribute filtering within a database interface. The method 100 (hereinafter “interface assistant manager”) is programmed within and resides within a non-transitory computer-readable storage medium as instructions that execute on one or more processors (hardware processors) of a network. Each processor specifically configured with and programmed to execute the interface assistant manager. Moreover, the network can be wired, wireless, or a combination of wired and wireless.

At 110, the interface assistant manager presents a graphical user interface (GUI) tool to a user. The GUI tool is an interface for the user to access a backend database. The screens of the GUI tool can be custom-defined or defined within an existing tool, such as a web browser. So, in some embodiments, the GUI tool can exist as applications and web pages within a web browser. In other cases, the GUI tool is a modification to an existing application that accesses an enterprise's database to include the features discussed herein and below.

According to an embodiment, at 111, the interface assistant manager provides the GUI tool as a marketing segmentation tool that is used for developing custom segments for marketing campaigns of an enterprise. In other words, the user can be an analyst of the enterprise that interacts with the GUI tool for purposes of developing a custom segmentation group that is to be the subject of the enterprise's marketing campaign.

At 120, the interface assistant manager receives, from the user, a field selection for a field of the database within the GUI tool. So, the user, via the GUI tool, picks a particular field of a particular database that is of interest to the user for a query to run against the database or for a report that is to be run against the database.

In an embodiment, at 121, the interface assistant manager detects a drop down menu activation from the user within the GUI tool that presents a field list for available fields to the user (based on the database being used within the GUI tool or a database table being used). The user then inspects the field list and selects the field of interest.

At 130, the interface assistant manager obtains, from the user, an attribute selection for an attribute assigned to the field within the GUI tool. So, the field selected includes a variety of attributes and the user picks a particular attribute. For example, suppose a selected field is “Sales Associate” and the attribute selected is “name;” from a list of available attributes that include such things as “store number, associate identifier, gender, phone number, etc.”

According to an embodiment, at 131, the interface assistant manager presents an attribute list for available attributes within the GUI tool based on the user selection of the field. In the prior example, an attribute list is presented to the user having attributes of: “name, store number, associate identifier, gender, phone number, etc.” The user then selects the “name” attribute in this example from the attribute list. The attributes are selected based on the user's selection of the field “Sales Associate.”

Continuing with the embodiment of 131 and at 132, the interface assistant manager inspects metadata associated with the selected field to determine the attribute list. That is, metadata for the fields include information for identifying attributes available for a given field.

At 140, the interface assistant manager displays within the GUI tool a first list of attribute values retrieved from the database and assigned to the attribute for the field. Each attribute includes a variety of values within the database and the values are displayed in the GUI once a particular field and a particular attribute are selected.

In a scenario, at 141, the interface assistant manager queries the database with the field and the attribute to acquire the attribute values, which are then used to populate the first list of attribute values within the GUI tool.

At 150, the interface assistant manager acquires from the user an attribute filter. A filter is one or more conditions that reduce a set of information. So, the attribute filter is used for filtering the first list of attribute values down to a reduced set as defined by the user. This reduced set is dynamically and in real time produced and presented within the GUI tool. Moreover, the reduced set is performed on an existing set of options provided within the GUI tool, namely the attribute values.

According to an embodiment, at 151, the interface assistant manager presents a filter list to the user within the GUI tool based on selection of the attribute. That is, each attribute can include one or more predefined filters that the user can select from once the attribute is selected by the user within the GUI tool.

Continuing with the embodiment of 151 and at 152, the interface assistant manager inspects metadata associated with the selected attribute to determine the filter list. That is, data identifying the filter list for each attribute can be carried within the GUI tool or separate from the data store and acquired.

At 160, the interface assistant manager filters the first list of attribute values to present a reduced second list of attribute values within the GUI tool by applying the attribute filter against the first list of attribute values. Thus, it can be seen how the GUI tool, via the interface assistant manager, provides a mechanism to reduce options presented for attribute values by allowing user-defined filters to be processed against the original options (attribute values).

In an embodiment, at 161, the interface assistant manager presents a total count for the second list of attribute values, which identifies a total number of attribute values within the second list of attribute values. This total count also presented within the GUI tool to the user, thereby allowing the user to see how much the original attribute values were reduced by applying the attribute filter.

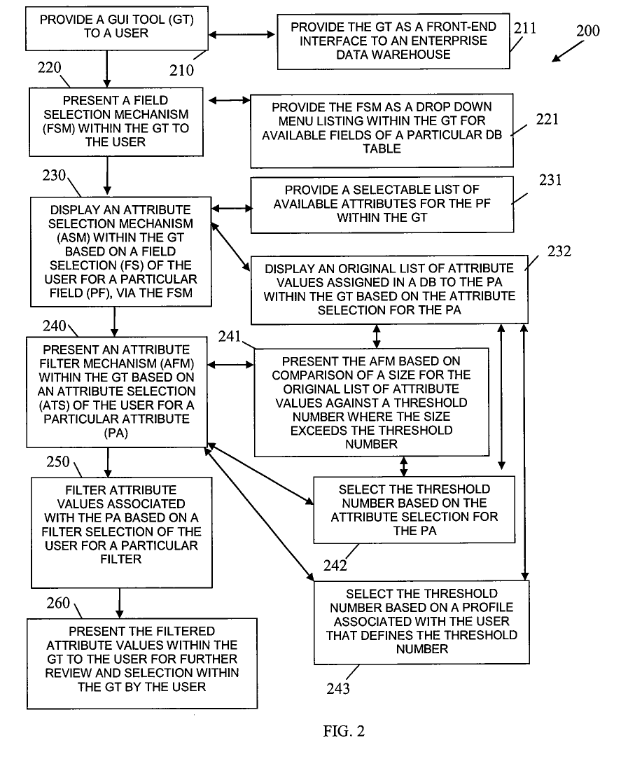

FIG. 2 is a diagram of another method 200 for independent attribute filtering within a database interface, according to an example embodiment. The method 200 (hereinafter “interface filter assistant”) is programmed within and resides within a non-transitory computer-readable storage medium as instructions that execute on one or more processors (hardware processors) of a network. Each processor specifically configured with and programmed to execute the interface filter assistant. Moreover, the network can be wired, wireless, or a combination of wired and wireless.

The interface filter assistant presents another and in some cases enhanced perspective of the interface assistant manager presented above with respect to the discussion of the FIG. 1.

At 210, the interface filter assistant provides a GUI tool to a user. Some examples of such a GUI tool were presented above with respect to the discussion of the FIG. 1.

In an embodiment, at 211, the interface filter assistant provides the GUI tool as a front-end interface to an enterprise data warehouse.

At 220, the interface filter assistant presents a field selection mechanism within the GUI tool to the user. For example, an entry field may allow a user to manually type in the field. Alternatively, a search can be done to obtain the field; or the user can browse for the field of interest.

In another case, at 221, the interface filter assistant provides the field selection mechanism as a drop down menu listing within the GUI tool for available fields of a particular database table.

At 230, the interface filter assistant displays an attribute selection mechanism within the GUI tool based on a field selection of the user for a particular field, via the field selection mechanism. The attribute selection mechanism can be similar to the field selection mechanism or different from the field selection mechanism.

According to an embodiment, at 231, the interface filter assistant provides a selectable list of available attributes for the particular field within the GUI tool.

In another situation, at 232, the interface filter assistant displays an original list of attribute values assigned in a database to the particular attribute within the GUI tool based on the attribute selection for the particular attribute. So, once the user selects the particular attribute, the interface filter assistant queries the database and obtains the attribute values, which are also presented to the user within the GUI tool.

At 240, the interface filter assistant presents an attribute filter mechanism within the GUI tool based on an attribute selection of the user for the particular attribute. Again, the attribute filter mechanism presented within the GUI tool can be the same as the field selection mechanism and/or the attribute selection mechanism. Alternatively, the attribute filter mechanism can be different from both the field selection mechanism and the attribute selection mechanism.

In an embodiment, at 241, the interface filter assistant presents the attribute filter mechanism based on a comparison of a size for the original list of attribute values against a threshold number where the size exceeds the threshold number. In other words, the interface filter assistant can make a dynamic decision on whether to even present the attribute filter mechanism based on an evaluation of how many attribute values are returned for the particular attribute.

Continuing with the embodiment at 241 and at 242, the interface filter assistant selects the threshold number based on the attribute selection for the particular attribute.

In another case of the embodiment at 241 and at 243, the interface filter assistant selects the threshold number based on a profile associated with the user that defines the threshold number.

At 250, the interface filter assistant filters attribute values associated with the particular attribute based on a filter selection of the user for a particular filter. So, the selected filter is processed to filter original attribute values to acquire a reduced set of the attribute values representing the filtered attribute values.

At 260, the interface filter assistant presents the filtered attribute values within the GUI tool to the user for further review and selection within the GUI tool by the user.

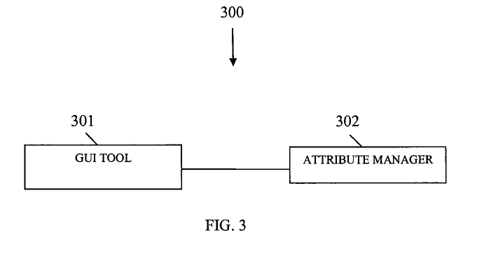

FIG. 3 is a diagram of an independent attribute filtering database interface system 300, according to an example embodiment. The independent attribute filtering database interface system 300 includes one or more processors that are configured to process a variety of components (discussed below). Each component is programmed within and resides within a non-transitory computer-readable medium as instructions that execute on the one or more processors over a network. The network is wired, wireless, or a combination of wired and wireless.

In an embodiment, the independent attribute filtering database interface system 300 implements, inter alia, the processing discussed above with respect to the methods 100 and 200 of the FIGS. 1 and 2, respectively.

The independent attribute filtering database interface system 300 includes a GUI tool 301 and an attribute manager 302. Each of these components and their interactions with one another will now be discussed in turn.

The GUI tool 301 is programmed within a non-transitory computer-readable medium and executes on a processor (hardware processor). Example aspects of the GUI tool 301 were presented above with respect to the FIGS. 1 and 2.

The GUI tool 301 is configured to be presented to a user and provide access to a database. The GUI tool 301 presents a field selection mechanism and an attribute selection mechanism to the user (such as was discussed above with respect to the FIG. 2).

The attribute manager 302 is programmed within a non-transitory computer-readable medium and executes on the processor. Processing associated with the attribute manager 302 was presented above with respect to the discussion of the FIGS. 1 and 2.

The attribute manager 302 is configured to monitor selections of the user and provide within the GUI tool 301 an attribute filtering mechanism to the user based on a particular attribute selection (also discussed above with respect to the FIG. 2).

The attribute manager 302 is also configured to filter original attribute values assigned in the database to the particular attribute selection to produce a reduced and filtered list of attribute values based on a filter selection from the attribute filtering mechanism.

According to an embodiment, the attribute manager 302 is also configured to resolve and to present within the GUI tool 301 a list of available attributes for the user to make the particular attribute selection based on a field selection for a particular field made by the user, via the field selection mechanism of the GUI tool 301.

In one case, the GUI tool 302 is a marketing segmentation tool.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented and programmed within a non-transitory computer-readable storage medium and processed by a processor, the processor configured to execute the method, comprising:
presenting a graphical user interface (GUI) tool to a user, the GUI tool acting as an interface for the user to access a database;
receiving, from the user, a field selection for a field of the database within the GUI tool;
obtaining, from the user, an attribute selection for an attribute assigned to the field within the GUI tool;
displaying within the GUI tool a first list of attribute values retrieved from the database and assigned to the attribute for the field;
acquiring, from the user, an attribute filter; and
filtering the first list to present a reduced second list of attribute values within the GUI tool by applying the filter against the first list.

2. The method of claim 1, wherein presenting further includes providing the GUI tool as a marketing segmentation tool that is used for assisting in developing custom segments for marketing campaigns of an enterprise.

3. The method of claim 1, wherein receiving further includes detecting a drop down menu activation from the user within the GUI tool that presents a field list for available fields to the user, the user selects the field from the field list.

4. The method of claim 1, wherein obtaining further includes presenting an attribute list for available attributes within the GUI tool based on the user selection of the field.

5. The method of claim 4, wherein obtaining further includes inspecting metadata associated with the selected field to determine the attribute list.

6. The method of claim 1, wherein displaying further includes querying the database with the field and the attribute to acquire the attribute values for populating the first list.

7. The method of claim 1, wherein acquiring further includes presenting a filter list to the user within the GUI tool based on selection of the attribute.

8. The method of claim 7, wherein acquiring further includes inspecting metadata associated with the selected attribute to determine the filter list.

9. The method of claim 1, wherein filtering further includes presenting a total count for the second list that identifies a total number of attribute values within the second list, the total count presented within the GUI tool to the user.

10. A method implemented and programmed within a non-transitory computer-readable storage medium and processed by a processor, the processor configured to execute the method, comprising:
providing a graphical user interface (GUI) tool to a user;
presenting a field selection mechanism within the GUI tool to the user;
displaying an attribute selection mechanism within the GUI tool based on a field selection of the user for a particular field, via the field selection mechanism;
presenting an attribute filter mechanism within the GUI tool based on an attribute selection of the user for a particular attribute;
filtering attribute values associated with the particular attribute based on a filter selection of the user for a particular filter; and
presenting the filtered attribute values within the GUI tool to the user for further review and selection within the GUI tool by the user.

11. The method of claim 10, wherein providing further includes providing the GUI tool as a front-end interface to an enterprise data warehouse.

12. The method of claim 10, wherein presenting the field selection mechanism further includes providing the field selection mechanism as a drop down menu listing within the GUI tool for available fields of a particular database table.

13. The method of claim 10, wherein displaying further includes providing a selectable list of available attributes for the particular field within the GUI tool.

14. The method of claim 10, wherein displaying further includes displaying an original list of attribute values assigned in a database to the particular attribute within the GUI tool based on the attribute selection for the particular attribute.

15. The method of claim 14, wherein presenting the attribute filter mechanism further includes presenting the attribute filter mechanism based on comparison of a size for the original list of attribute values against a threshold number where the size exceeds the threshold number.

16. The method of claim 15, wherein presenting the attribute filter mechanism further includes selecting the threshold number based on the attribute selection for the particular attribute.

17. The method of claim 15, wherein presenting the attribute filter mechanism further includes selecting the threshold number based on a profile associated with the user that defines the threshold number.

18. A processor-implemented system, comprising:
a graphical user interface (GUI) tool programmed within a non-transitory computer-readable medium and to execute on a processor; and
an attribute manager programmed within a non-transitory computer-readable medium and to execute on the processor;
the GUI tool is configured to be presented to a user and provide access to a database, the GUI tool presents a field selection mechanism and an attribute selection mechanism to the user, the attribute manager configured to monitor selections of the user and provide within the GUI tool an attribute filtering mechanism to the user based on a particular attribute selection, the attribute manager is also configured to filter original attribute values assigned in the database to the particular attribute selection to produce a reduced and filtered list of attribute values based on a filter selection from the attribute filtering mechanism.

19. The system of claim 18, wherein the attribute manager is also configured to resolve and to present within the GUI tool a list of available attributes for the user to make the particular attribute selection based on a field selection for a particular field made by the user via the field selection mechanism of the GUI tool.

20. The system of claim 18, wherein the GUI tool is a marketing segmentation tool.
